(19) United States
(12) Patent Application Publication
(10) Pub. No.: US 2020/0074433 A1
(43) Pub. Date: Mar. 5, 2020

(54) PROCESSING A TRANSACTION USING MULTIPLE PAYMENT ACCOUNTS BY A PAYMENT NETWORK

(71) Applicant: MASTERCARD INTERNATIONAL INCORPORATED, Purchase, NY (US)

(72) Inventors: Gautam Chopra, New Delhi (IN); Sibasis Mohanty, Gurugram (IN); Ashish Mathew, New Delhi (IN)

(21) Appl. No.: 16/118,260

(22) Filed: Aug. 30, 2018

(51) Int. Cl. G06Q 20/22; G06Q 20/40

(52) U.S. Cl. CPC G06Q 20/227; G06Q 20/401

(57) ABSTRACT

The disclosure herein describes processing a transaction across multiple accounts. A multi-source payment request associated with the first transaction is received at a payment network. The request is associated with source account identifiers of the multiple accounts and it includes a merchant identifier a first amount of the transaction. A virtual account identifier associated with the multi-source payment request is generated and provided in response to the request. An authorization request associated with the first transaction and including the virtual account identifier is received from the merchant. A plurality of second transactions associated with the source account identifiers is created and the processing of the plurality of second transactions is then performed, whereby the first transaction is processed. The described system provides enhanced flexibility for users in paying for purchases while insulating merchants from increased complexity of handling transactions with multiple accounts.

### BACKGROUND

E-commerce has become a popular way to purchase all sorts of goods and services. Merchants provide e-commerce interfaces that can be accessed by customers from all over the world and at any time of day. However, many merchant interfaces do not enable customers to make payments for transactions using multiple accounts. Customers are limited to paying for transactions with either a credit card account, a debit account, or the like. While there are situations in which a customer may want to split a purchase across multiple accounts, merchants may be unable or unwilling to make the necessary infrastructure and/or interface changes to handle the potential complexity of such transaction payments.

Further, many customers may have a large variety of accounts to choose from when providing payment for transactions. Many accounts may include benefits (e.g., loyalty reward points for certain types of purchases, etc.) and/or requirements (e.g., a user must make at least a defined number of purchases with an account to maintain certain benefits of the account, etc.). Keeping track of all the possible payment accounts and associated aspects may be challenging to do manually, resulting in the customer missing out on some potential benefits associated with their accounts or transactions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method and system for processing a first transaction across multiple accounts is described. A multi-source payment request associated with the first transaction is received, via a network connection. The request is associated with source account identifiers of the multiple accounts and it includes a merchant identifier of a merchant associated with the first transaction and transaction data including a first amount of the first transaction. A virtual account identifier associated with the multi-source payment request is generated and the generated virtual account identifier is provided in response to the request. After providing the virtual account identifier, an authorization request associated with the first transaction and including the virtual account identifier is received from the merchant. A plurality of second transactions is created based on the multi-source payment request, wherein the plurality of second transactions are associated with the source account identifiers of the multiple accounts and a sum of transaction amounts of the plurality of second transactions equals the first amount of the first transaction. The processing of the plurality of second transactions is then performed, whereby the first transaction is processed and the merchant is insulated from processing the plurality of second transactions.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a system configured for initiating and processing transactions between merchants and users using a plurality of user accounts according to an embodiment;

FIG. 2 is an exemplary block diagram illustrating components and interactions of the payment network in FIG. 1 according to an embodiment;

FIG. 3 is an exemplary diagram illustrating a graphical user interface enabling a user to configure a multi-source payment according to an embodiment;

FIG. 4 is an exemplary flow chart illustrating the initial processing of a multi-source payment according to an embodiment;

FIG. 5 is an exemplary sequence diagram illustrating interactions between entities of FIG. 1 during the initiation of a multi-source payment; and

FIG. 6 illustrates a computing apparatus according to an embodiment as a functional block diagram.

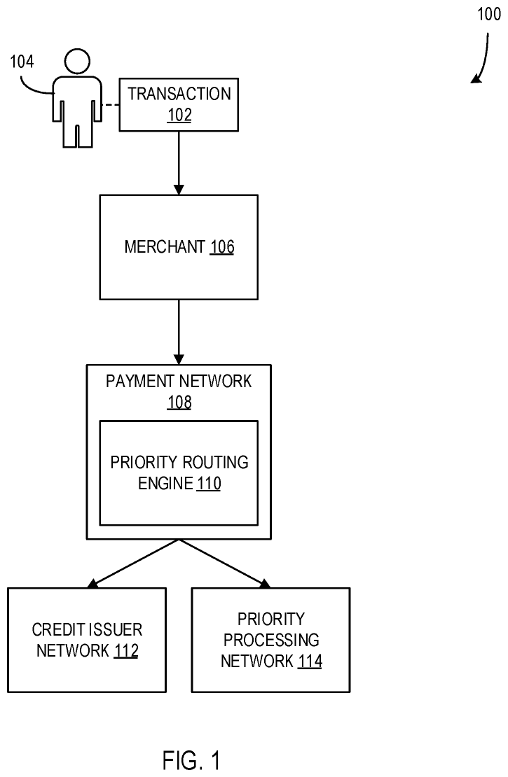

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a system and method for processing a transaction across multiple accounts by a payment network. The payment network receives a multi-source payment request associated with a first transaction and generates a virtual account identifier in response. The multi-source payment request is associated with source account identifiers of multiple accounts selected for paying for the transaction. The generated virtual account identifier is provided to either the merchant or a user in response to the multi-source payment request. Then, an authorization request associated with the transaction that includes the virtual account identifier is received by the payment network. The payment network creates a plurality of secondary transactions associated with the source account identifiers and authorizes the plurality of secondary transactions with issuers associated with the source account identifiers associated with the multi-source payment request. Upon the secondary transactions being successfully authorized, the secondary transactions are caused to be processed, whereby the first transaction is also caused to be processed (e.g., any additional processes necessary to complete the first transaction and the secondary transactions, such as clearance processes, settlement processes, or the like, may be performed, etc.).

The described universal payment system provides users with a flexible way in which to use a variety of accounts to pay for a single e-commerce transaction, even when the merchant e-commerce interface or portal itself does not support the use of multiple accounts. Users are further provided with functionality that enables them to configure preferred accounts based on merchant and/or transaction context data, and to be provided system-generated recommendations regarding accounts to be used based on transaction context data, transaction history data, and/or other factors. Additionally, payment networks assume the additional processing overhead associated with splitting payments between multiple accounts, sparing merchants from having to provide the functionality in unique implementations in their e-commerce interfaces. In some examples, the system provides for the use of specialized application program interfaces (APIs) that enable the use of the universal payment system in conjunction with a merchant e-commerce interface, enhancing the process of configuring a universal payment to be substantially seamless with the process of making an online purchase. The disclosure operates in an unconventional manner to enable users to make purchases across multiple accounts by leveraging the position and information access of the payment network to reduce implementation and processing costs for merchants and to reduce exposure of user account data through the use of virtual account identifiers as described herein, thereby increasing user account security.

FIG. 1 is an exemplary block diagram illustrating a system 100 configured for initiating and processing a transaction 105 between a merchant 108 and a user 102 using a plurality of user accounts 114-116 according to an embodiment. The system 100 includes a user 102 with a user device 104 that is configured to initiate a transaction 105 with a merchant 108 via a network 106. The user device 104 may be a personal computer, a laptop computer, a tablet, a mobile phone, etc. Further, in some examples, the user device 104 may include a personal device in the possession of the user 102 in combination with another computing device, such as a server device, such that the functionality of the user device 104 described herein may be performed by multiple computing devices and/or in a distributed manner.

Initiating the transaction 105 with merchant 108 may include the user 102 selecting one or more products or services for sale by the merchant 108, providing payment information (e.g., information associated with a payment account (e.g., a credit account, a debit account or other bank account, a loyalty rewards account, a gift card account, etc.), a virtual account identifier as described herein, etc.), and generating and/or confirming the transaction 105 based on the selected products or services and the provided payment information. For instance, the user 102 may use the user device 104 to access a website of the merchant 108 (e.g., the e-commerce interface 118, etc.), view the offered products and/or services, select one or more of the offered products and/or services, and initiate a transaction based on the selection. Online shopping for products and/or services via a website or other e-commerce interface or portal is well-understood in the art and it should be understood that the interaction between the user 102 and user device 104 and the merchant 108 may be enabled using any known e-commerce functionality without departing from the description herein.

The network 106 includes one or more computer networks that are configured to enable network communications between the user device 104 and devices associated with the merchant 108 and/or the merchant's e-commerce interface 118. Other components of the system 100, such as the acquirer 110, the payment network 112, and the issuers 114-116, are also connected to the network 106 and it should be understood that communications between components of the system 100 may be performed using network connections on the network 106 as would be understood by a person of ordinary skill in the art of computer networks and communications. The network 106 may include a plurality of networks (e.g., private intranets, public networks such as the Internet, etc.) and/or network types (e.g., wired networks, wireless networks such as Wi-Fi networks or cellular networks, etc.). The network 106 may include any hardware, firmware, and or software arranged in hierarchies or structures that enable the components of the system 100 to communicate as described without departing from the description herein.

The merchant 108 includes at least one computing device, such as a web server, configured to provide the e-commerce interface 118 and cause the transaction 105 to be received and then processed via communications with an acquirer 110 at 109. The merchant 108 further includes the e-commerce interface 118 that is used by the user 102 and other users, customers, or the like to shop for and purchase goods and/or services offered by the merchant 108. The e-commerce interface 118 may include a website, mobile application portal, or other type of portal that provides users access to the merchant's goods and/or services. The e-commerce interface 118 may further be configured to expose and/or make use of application program interfaces (APIs) that provide additional functionality (e.g., an API of the universal payment interface 120 as described herein, etc.).

The acquirer 110 is configured to receive transaction information associated with the transaction 105 from the merchant 108 and continue the processing of transaction 105 via communications to the payment network 112 at 111. In some examples, the acquirer 110 is a bank or other financial entity with which the merchant 108 has an account and/or does business. The general functionality provided by an acquirer in the processing of transactions is well-understood in the art and the acquirer 110 may perform the functions and/or operations of an acquirer in processing the transaction 105 in any known manner without departing from the description.

The payment network 112 is configured to receive transaction information from the acquirer 110 and continue processing the transaction 105 via communications with the plurality of issuers 114-116 at 113. The payment network 112 provides transaction processing services and serves to facilitate communications and/or interactions between acquiring entities (e.g., acquirer 110, etc.) and issuing entities (e.g., issuers 114-116, etc.). Like the acquirer 110, the general functionality of a payment network in the processing of transactions is well understood in the art and the payment network 112 may be configured to perform such functions and/or operations in any known manner without departing from the description. Further, the payment network 112 includes a universal payment interface 120 and a universal payment engine 122.

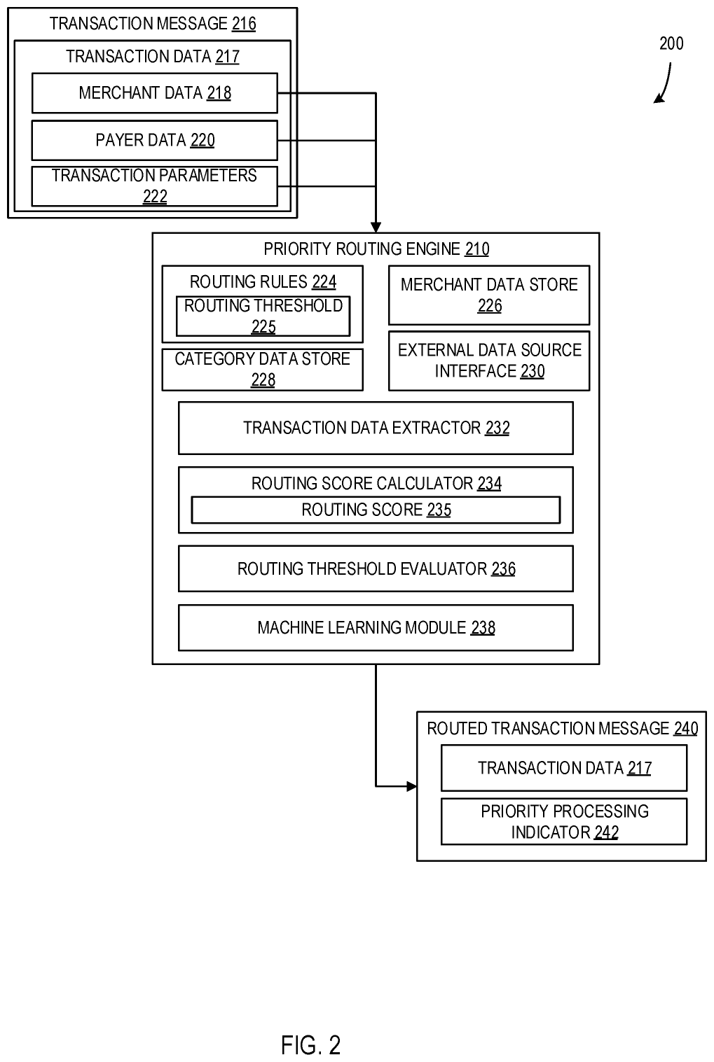

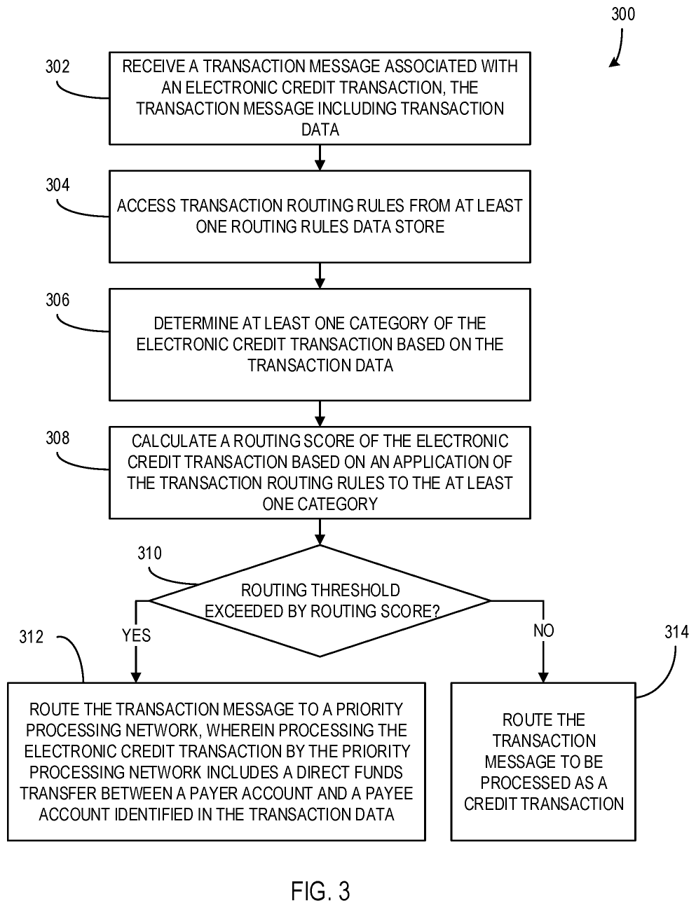

The universal payment interface 120 and universal payment engine 122 enable the use of “universal payments”, or payments from multiple source accounts, to pay for goods and/or services in transactions (e.g., transaction 105, etc.). A universal payment enables the user 102 to pay for transaction 105 from multiple accounts (e.g., user accounts 124-126, etc.) when the merchant 108 and the associated e-commerce interface 118 are not configured to handle multi-source payments. The payment network 112 is configured to handle any additional processing overhead that is associated with creating and processing multiple transactions in order to split the cost of the transaction 105 across the multiple accounts of the user 102, sparing the merchant 108 from having to implement the functionality. The universal payment interface 120 and universal payment engine 122 are described in greater detail below with respect to FIGS. 2 and 3.

The issuers 114-116 are banks or other financial entities that offer and manage financial accounts (e.g., credit accounts, debit or checking accounts, savings accounts, etc.) for user 102 and other users. Like the acquirer 110, the general functionality of an issuer in the processing of transactions is well understood in the art and the issuers 114-116 may be configured to perform such functions and/or operations in any known manner without departing from the description. The user 102 has user accounts 124-126 with the issuers 114-116 respectively and, through the use of the system 100 as described herein, the user 102 may select one or more user accounts 124-126 for use in payment of portions of the total amount of the transaction 105. While FIG. 1 shows only two issuers and associated accounts, in other examples, the system 100 may include more and/or different issuers and/or accounts without departing from the description.

FIG. 2 is an exemplary block diagram 200 illustrating components and interactions of the payment network in FIG. 1 according to an embodiment. The universal payment interface 220 is configured to send a multi-source payment request 232 to the universal payment engine 222 and to further interact with merchants, users, and/or the universal payment engine 222 during the operations described herein. The universal payment engine 222 is configured to receive a multi-source payment request 232, generate virtual account identifier 244 and associated transactions, receive authorization request 252, and send secondary authorization messages 256 as described herein.

In some examples, the universal payment interface 220 includes application program interfaces 228 (APIs) and graphical user interfaces 230 (GUIs). The APIs 228 may include interfaces that are configured for interacting with software on a user's computing device and/or with software on a merchant computing device. For instance, an API 228 may be exposed for use by a merchant web server, such that users of the merchant's website are enabled to access the universal payment interface 220 of a payment network, via a web form, web portal, or the like, in order to set up a universal payment to the merchant. Alternatively, or additionally, the APIs 228 may include an API that is exposed for use by software on the user's device, enabling the user to configure a universal payment for use in a transaction as described herein. Alternatively, or additionally, the universal payment interface 220 may include APIs 228 that are configured for communication and/or interaction with issuers (e.g., issuers 114-116, etc.). APIs 228 for interaction with issuers may include interfaces for obtaining transaction data from the issuers (e.g., for recommendation generation, etc.), interfaces for facilitating the processing of transactions with the issuers, and/or interfaces for any other interactions with issuers that may be necessary to perform the operations described herein. For instance, the universal payment interface 220 in combination with the universal payment engine 222 may be configured to communicate with issuers to verify that issued accounts should be usable in universal payments, to facilitate issuer participation with universal payment rewards programs or other programs, to enable partnered issuers to provide interfaces and/or other access to the universal payment system, thereby providing partnered issuers with use of the universal payment system as a payment platform, or the like.

The GUIs 230 of the interface 220 are configured to display information to and receive information from a user of the described universal payment system when configuring and/or processing a universal payment. A GUI 230 may include, for instance, areas for displaying text and/or graphics, text entry components, button components, checkbox components, etc. It should be understood that a GUI 230 may include any and/or all components as would be understood by a person of ordinary skill in the art without departing from the description. An exemplary GUI of the universal payment interface 220 is described in greater detail below with respect to FIG. 3.

In some examples, the APIs 228 and/or the GUIs 230 are configured to collect or otherwise receive data associated with a multi-source payment request 232 and provide the data to the universal payment engine 222. The multi-source payment request 232 is a data structure that includes data necessary for generation and configuration of a universal payment as described herein. Source account identifiers 234 are identifiers (e.g., account numbers, etc.) of the accounts (e.g., user accounts 124-126, etc.) that the user has selected for paying the transaction amount. The user may have selected one or more source accounts and the source account identifiers 234 include a unique identifier for each selected source account. Each source account identifier 234 may be associated with an amount value representing the portion of the transaction amount 240 that is to be paid from the associated account.

The merchant identifier 236 is an identifier of the merchant associated with the transaction. It may include a unique identifier, such as a unique code associated with a specific merchant and/or it may include a non-unique identifier, such as a name of the merchant, etc. In some examples, the merchant identifier 236 may be provided based on the interaction of the universal payment interface 220 with the merchant (e.g., the merchant identifier may be provided through an API 228 used by a server device at the merchant, etc.). Alternatively, or additionally, the merchant identifier 236 may be provided or confirmed by a user using an API 228 and/or a GUI 230 (e.g., a user enters a name of the merchant into a GUI, a user selects the merchant from a list of possible merchants, thereby choosing the associated merchant identifier 236, etc.).

The transaction data 238, including the transaction amount 240, represents the transaction with which the universal payment is associated. The transaction amount 240 is the total amount to be paid for the transaction. The transaction data 238 may include other information and/or data values, such as transaction date and/or time data, a type or genre of transaction (e.g., a book purchase, a clothing purchase, a travel-based purchase, etc.), etc. Other exemplary data elements of the transaction data 238 may include card and/or account numbers, tokenized card numbers, issuer and/or merchant country or location data, transaction portfolio data, issuer identification data such as an issuer name, card or product type, decline reasons, fraud reasons, etc. Such transaction data 238 may be used by the universal payment engine 222 during the generation of the universal payment as described below. As with the merchant identifier 236, the transaction data 238 and transaction amount 240 may be provided via an API 228 in communication with a computing device of the merchant and/or they may be provided by the user via a GUI 230.

While the multi-source payment request 232 is shown as a single data structure, it should be understood that, in some examples, the data of the request 232 may be transferred to the universal payment interface 220 and then to the universal payment engine 222 in a series of multiple interactions. For instance, the GUIs 230 may be configured to collect portions of the data of the request 232 sequentially (e.g., first the merchant identifier 236 is collected, then the transaction data 238 and/or amount 240 are collected, and then the source account identifiers 234 are collected, etc.). Other sequences of data collection may be implemented without departing from the description.

In some examples, portions of the transaction data 238, such as the transaction amount 240, may not be available until later in the process, such as when the authorization message 252 is received. In such a case, the selected source account identifiers 234 may be associated portions of the transaction amount 240 that may not be precisely determined until the transaction amount 240 is received. For instance, each source account identifier 234 may be associated with a percentage value that is applied to the transaction amount 240 once it is received. Alternatively, or additionally, each source account identifier 234 may be associated with a maximum amount to be paid from the associated account and/or a priority order in which the transaction amount 240 is divided between the accounts of the source account identifiers 234. For instance, a top priority account may be associated with a maximum value of $50, a second priority account may be associated with a maximum value of $100, and a third priority account may be not limited to an amount, such that a transaction amount of $200 is divided between the three accounts by assigning $50 to the top priority account, $100 to the second priority account, and the remaining $50 to the third priority account.

The universal payment engine 222 of a payment network (e.g., payment network 112, etc.) includes hardware, firmware, and/or software configured for generating and processing transactions based on a multi-source payment request 232. The universal payment engine 222 is configured to interact with the universal payment interface 220 to collect, provide, and/or display data associated with a transaction and an associated universal, or multi-source, payment. The universal payment engine 222 includes an account ID generator 242 that is configured to generate a virtual account identifier 244, a user profile or profiles 246, a recommendation generator 248, and a transaction manager 250.

The account ID generator 242 is configured to generate a virtual account identifier 244 in response to the universal payment engine 222 receiving a multi-source payment request 232. The generated virtual account identifier 244 may take the form of a credit card number, debit card number, or other number or identifier of a virtual account. The account ID generator 242 may be configured to generate IDs that indicate that they are virtual account IDs rather than IDs associated with credit accounts, debit accounts, or other types of accounts. In some examples, the virtual account identifier 244 is generated in a format that can be entered as an account number at an account number entry prompt on a merchant e-commerce interface (e.g., e-commerce interface 118, etc.), thereby causing the merchant to initiate transaction processing using the virtual account identifier 244. The format and/or pattern of the virtual account identifier 244 causes the transaction processing to be directed to and performed by the payment network associated with the universal payment engine 222. Further, the account ID generator 242 may be configured to generate identifiers that avoid overlap or collision with other existing account identifiers (e.g., bank account numbers, credit card numbers, etc.).

The generation and use of the virtual account identifier 244 may also provide additional security for users' accounts. The use of the virtual account identifier 244 at a merchant's website masks the user's actual account data and may prevent it from falling into the wrong hands through identity theft or the like. In some examples, the generation of the virtual account identifier may include generating an active interval for the virtual account identifier to define a time interval during which the virtual account identifier must be used (e.g., a 10-minute interval, a 30-minute interval, etc.). The inclusion of the interval may provide additional security for the transaction, such that, if the virtual account identifier is obtained by another party, it will not be usable to pay for transactions outside of the active interval. Further, the virtual account identifier may be associated with the merchant identifier and/or other context information associated with the transaction, such that those associated aspects are confirmed to be present in the transaction prior to authorizing payments using the virtual account identifier as described herein.

The universal payment engine 222 includes a user profile 246 associated with a user (e.g., user 102, etc.). The universal payment engine 222 may further include a plurality of user profiles for a plurality of other users. The user profile 246 may include user data specific to the associated user, such as payment account data, preference data, or the like. Identifiers for payment accounts that a user may select for use with a universal payment may be stored in the user profile 246. Further, the user may configure payment preferences that the universal payment engine 222 uses during interactions with the user. For instance, the user may configure a preference that indicates that a credit account is preferred and, as a result of the preference, the universal payment engine 222 may recommend the preferred account to the user when the user is selecting accounts to use in a universal payment. The recommendation may be in the form of the preferred account being highlighted and/or placed at the top of a list of available payment accounts. Alternatively, or additionally, a user may configure preferences that define when a payment account is disabled and/or not available for use in a transaction. For instance, a user preference may indicate that a credit card account should be disabled after it has been used to pay amounts that exceed a defined threshold (e.g., greater than $500, etc.) in the past month.

User profile preferences may further be configured to take account of context data of the transaction (e.g., the merchant associated with the transaction, the type of transaction, etc.) and/or data associated with previous payment account use (e.g., amount values that have been paid from accounts during the current month, etc.). For instance, a user may set up a preference that indicates a credit account that provides travel reward points should be recommended for transactions that are travel-based. Alternatively, or additionally, the user may configure a preference that indicates that, if a total transaction amount is greater than $500, a particular payment account should not be recommended for use in paying for the transaction. The user profile 246 may be configured to store current and/or past transaction data and payment data for use in evaluating the user's preferences and providing the desired recommendations (e.g., past payment data indicating total amounts spent from each payment account, etc.). Further, such data may be obtained by the payment network as necessary if the payment network is capable of accessing the data.

In some examples, the universal payment engine 222 includes a recommendation generator 248 that is configured to automatically make recommendations of payment accounts as described above with respect to the user preferences. For instance, the recommendation generator 248 may be configured to determine payment accounts that would provide loyalty rewards for a transaction and recommend those payment accounts for use in that transaction. Alternatively, or additionally, when the recommendation generator 248 has access to account balances, recommendations may be made based on which payment accounts have sufficient balances for use in the transaction and/or balances may be provided to the user when prompting the user select payment accounts. The recommendations may include an indication or reason why the recommendation is being made (e.g., “this recommendation is based on a user preference”, “this account will provide the highest loyalty rewards”, etc.). In other examples, a payment account may provide benefits to a user when the account is used for a minimum number of transactions each month. The recommendation generator 248 may be configured to recommend the payment account for payment of transactions until the minimum number of transactions is met for the account.

In other examples, the universal payment engine 222 may be configured to enable users to pay using loyalty rewards and/or points, as well as provide recommendations from the recommendation generator 248 based on the use of loyalty rewards as payment (e.g., rewards account A is recommended because it includes loyalty rewards that can be applied to the current transaction, etc.).

Further, in some examples, a rewards program associated with the universal payment system of the payment network may be implemented and recommendations may be made based on potential rewards earnings when using the universal payment system to pay for transactions. For instance, different types of accounts or accounts with different issuers may earn rewards or points from the universal payment rewards program at different rates and the recommendation generation 248 may generate recommendations of accounts that enhance and/or maximize the earned rewards or points.

Alternatively, or additionally, the universal payment manager 222 and/or the recommendation generator 248 may be configured to identify patterns of account use in transactions based on transaction data stored by the payment network and/or associated issuers for transactions of the user and/or other users. Recommendations may be generated by the recommendation generator 248 to recommend accounts to a user that may be similar to accounts used in the past and/or by other users for similar transactions. For instance, a recurring transaction that the user pays monthly with a particular set of accounts may result in that set of accounts being recommended for use with the next instance of the recurring payment. Alternatively, or additionally, similarities between a current transaction and past transactions in a transaction database of the payment network may be identified and types of accounts or accounts associated with particular issuers that are frequently used during similar past transactions may be recommended to the user for use in paying for the current transaction.

The transaction manager 250 of the universal payment engine 222 is configured to create and manage transactions with the selected source accounts based on the received multi-source payment request 232. The transaction manager 250 receives the source account identifiers 234 and associated transaction amounts assigned to each source account as input and, upon the payment network receiving a request or instruction to process the associated transaction from the merchant, the transaction manager 250 is configured to create and initiate transactions with each of the source accounts identified by the source account identifiers 234. In some examples, after the virtual account identifier 244 is generated, it is provided to the user, who may then provide it to the merchant associated with the transaction. Alternatively, or additionally, the payment network may provide the generated virtual account identifier 244 to the merchant via an API 228 of the universal payment interface 220. The virtual account identifier 244 is then treated as an account identifier of an actual payment account and the processing of the transaction is initiated. The transaction processing may include the merchant and/or an associated acquirer sending an authorization request 252 to the payment network and the associated universal payment engine 222. The authorization request includes the virtual account identifier 244 and any associated transaction data 254 (e.g., date-time data, merchant data, merchant account data, transaction context data, etc.). It should be understood that the process of the payment network receiving an authorization request is well-known in the art and the interaction may be performed according to any known method without departing from the description.

Upon the authorization request 252 being received by the payment network, the virtual account identifier 244 is recognized and the request is provided to the universal payment engine 222 for additional processing, including the creation and management of the secondary transactions with the selected source accounts. In some examples, the transaction manager 250 creates each of the secondary transactions upon receiving the multi-source payment request 232 but refrains from processing them until authorization request 252 is received. Alternatively, the transaction manager may wait to create the secondary transactions until the authorization request 252 is received.

In some examples, the transaction manager 250 is configured to send secondary authorization messages 256 to the issuers (e.g., issuers 114-116, etc.) of the associated source accounts (e.g. user accounts 124-126, etc.) based on the authorization request 252. The transaction manager 250 is configured to track the progress of the processing of the secondary transactions throughout authorization, clearance, and/or settlement. The transaction manager 250 may further be configured for transaction processing that includes more, fewer, or different operations without departing from the description.

Secondary authorization messages 256 generated by the transaction manager 250 each include a source account identifier 234 and an associated transaction amount 258. The messages 256 may further include other transaction data that may be necessary for processing the associated secondary transactions (e.g., date-time data, merchant data, merchant account data, etc.). For each transaction for which the universal payment engine 222 receives an authorization request 252, the transaction manager 250 may generate two or more secondary authorization messages 256, depending on how many source account identifiers 234 are selected by the user and included in the multi-source payment request 232.

The components of the universal payment engine 222 (e.g., the account ID generator 242, the user profile 246, the recommendation generator 248, and the transaction manager 250, etc.) may be configured to interact with the GUIs 230 of the universal payment interface 220 to collect data from the user and/or display data to the user. For instance, the recommendations generated by the recommendation generator 248 may be displayed on a GUI 230 for selection during collection of the data for the multi-source payment request 232. Further, the universal payment engine 222 may be configured to communicate and/or interact with the APIs 228 of the universal payment interface 220 to collect data from the user or merchant and/or provide data to the user or merchant as described herein.

FIG. 3 is an exemplary diagram illustrating a graphical user interface 330 (GUI) enabling a user to configure a multi-source payment according to an embodiment. The GUI 330 is configured to be displayed on a display component of a user device (e.g., user device 104, etc.). The GUI 330 includes a merchant section 360, a payment amount section 362, a payment accounts section 364, a universal payment number section 366, a generate payment button 368, and a cancel button 370.

The merchant section 360 includes a “merchant” label and a text entry box. The text entry box may be configured to enable a user to enter a merchant name or other merchant identifier. Additionally, or alternatively, the merchant text entry box may be populated automatically based on data retrieved from the merchant (e.g., via a universal payment interface 220 as described above, etc.). In further examples, a user may be provided a list of potential merchants to select from or otherwise prompted to provide a merchant identifier.

Similarly, the payment amount section 362 includes a “payment amount” label and text entry box for the total amount of the transaction. The text entry box may be configured to enable the user to enter the transaction amount and/or the text entry box may be populated automatically based on data retrieved from the merchant (e.g., the user may select the items to purchase on the merchant website and the GUI 330 may obtain the total calculated amount from the merchant website via an API 228 of the universal payment interface 220 as described above, etc.).

The payment accounts section 364 includes a list of potential source accounts that the user is enabled to select for paying for the transaction. The listed source accounts may be obtained from the user's profile (e.g., user profile 246, etc.). Each row of the list includes a source account, a checkbox for selecting the associated source account, and an entry box enabling the user to enter a payment amount to come from the associated account. A source account row may further include information specifically identifying the source account (e.g., the last four digits of the account number, etc.) as well as other information pertaining to the source account, such as whether the account is recommended based on user preferences and/or by a recommendation generator (e.g., the recommendation generator 248, etc.). As shown, the first row is for a credit account B, the account number of which ends in XXXX. Account B is a recommended account for use in paying for the associated transaction. The order of the list of the section 364 may be based on accounts that are recommended, accounts most commonly used, accounts that are not available for the transaction, or the like. For instance, credit account B may be in the first row of the section 364 due to being the only recommended account.

Credit account B and bank account C have been selected for paying for the transaction as shown by the checked check boxes to the left of the account names. Each has been assigned a value (e.g., $65 for credit account B and $35 for bank account C, etc.). In some examples, the GUI 330 may display an amount that remains to be assigned to payment accounts based on the difference between the payment amount in section 362 and the assigned payment values of the currently selected account rows in the section 364 (e.g., the GUI 330 may provide a reminder that an additional $10 must be assigned if the payment amount is $100 and $90 have been assigned to source accounts in the section 364, etc.).

Bank account D and travel rewards account E are not selected for use, as demonstrated by the associated unchecked check boxes. Bank account D is available for use, but the checkbox of travel rewards account E is illustrated with a dotted line, indicating that the checkbox is disabled and/or not available. Travel rewards account E may be limited to use for specific types of transactions, such as travel-based transactions, and the illustrated transaction may be of another type. Other types of account limitations (e.g., limitations based on aspects of the account, limitations based on defined user preferences, etc.) may result in limited access on a GUI 330 as shown without departing from the description.

The amount entry boxes of bank account E and travel rewards account E are illustrated with dotted lines indicating that the boxes are disabled because the associated accounts are not selected for use with the current transaction.

The universal payment number section 366 includes a “universal payment number” label and a text box that is configured to display a generated universal payment number, which is a virtual account identifier (e.g., virtual account identifier 244, etc.) associated with the transaction. The text box of section 366 may be disabled such that the user cannot enter text, such that the text box is only populated by the universal payment engine upon the generation of the universal payment number, as described herein.

Upon the user completing sections 360, 362, and 364, the generate payment button 368 may be activated, causing the associated universal payment engine to generate a universal payment number. The generated universal payment number is populated to section 366, displaying the number to the user and enabling the user to use the number to initiate payment for the associated transaction. For instance, the user may copy and paste the universal payment number into a form on the merchant website to initiate the purchase. Alternatively, or additionally, the generated universal payment number may further be provided to the merchant via an API. The information from the completed sections 360, 362, and 364 may also be provided to a universal payment engine for use in creating and managing transactions with the selected payment accounts as described herein.

The cancel button 370 may be activated by the user to exit the GUI 330 or otherwise cancel the generation and/or processing of the universal payment.

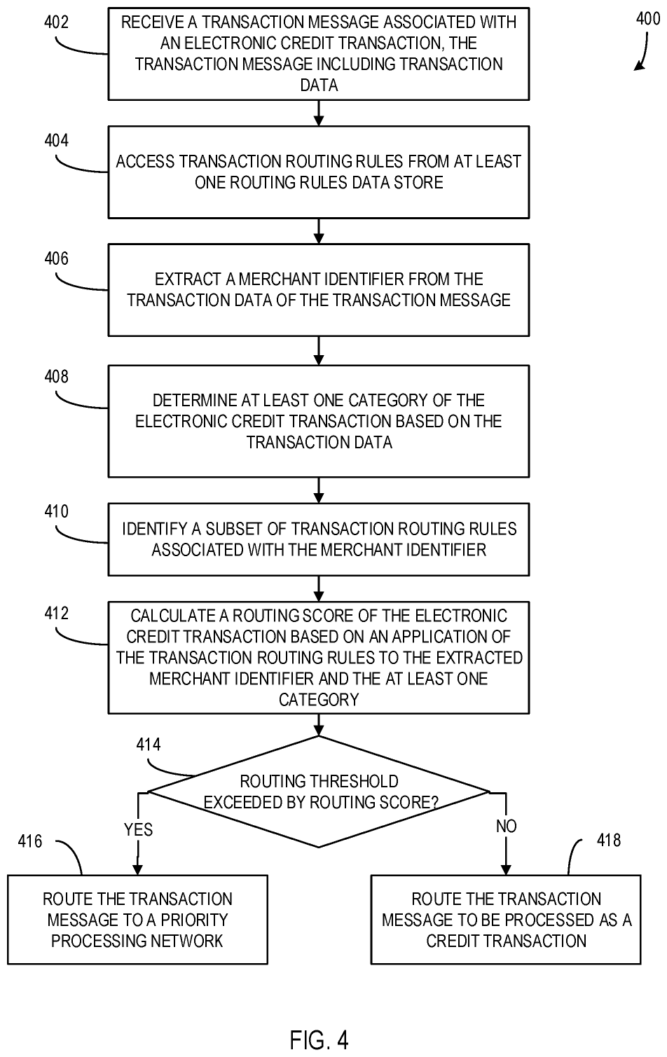

FIG. 4 is an exemplary flow chart 400 illustrating the initial processing of a multi-source payment according to an embodiment. In some examples, the operations described in FIG. 4 may be performed by a payment network, such as payment network 112 of FIG. 1, and associated components (e.g., universal payment interface 220 and/or universal payment engine 222, etc.). At 402, a multi-source payment request (e.g., multi-source payment request 232, etc.) associated with a first transaction (e.g., transaction 105, etc.) is received, wherein the request is associated with source account identifiers (e.g., source account identifiers 234, etc.) of multiple accounts (e.g., user accounts 124-126, etc.). The multi-source payment request may further include a merchant identifier (e.g., merchant identifier 236, etc.) of a merchant (e.g., merchant 108, etc.) associated with the first transaction and transaction data (e.g., transaction data 238, etc.) including a first amount (e.g., transaction amount 240, etc.) of the first transaction. A universal payment engine of a payment network may receive the multi-source payment request from APIs and/or GUIs as described herein, and the data of the request may be collected from the merchant, the user, or a combination of both without departing from the description herein.

At 404, a virtual account identifier (e.g., virtual account identifier 244, etc.) associated with the multi-source payment request is generated. The virtual account identifier may be stored with the request by a universal payment engine, thus enabling the universal payment engine to handle the processing of the associated transaction through the use of the associated data and identifiers. In some examples, the virtual account identifier is generated in a format that is compatible with account number entry operations used on e-commerce interfaces of merchants, enabling a user to enter the virtual account identifier when providing payment information for the transaction.

At 406, the generated virtual account identifier is provided in response to the multi-source payment request. The virtual account identifier may be provided to the user, enabling the user to enter it as payment information when initiating the transaction with the merchant. Alternatively, or additionally, the virtual account identifier may be provided to the merchant via an API as described herein.

After the virtual account identifier is provided, an authorization request associated with the transaction and including the virtual account identifier is received at 408. The universal payment engine waits for the receipt of the authorization request, which may come from the merchant and/or an acquirer associated with the merchant, as described above with respect to FIG. 1.

At 410, in response to receiving the authorization request, a plurality of second transactions based on the multi-source payment request are created, wherein the plurality of second transactions are associated with the source account identifiers of the multiple accounts. Further, the sum of transaction amounts for the plurality of second transactions may equal the first amount of the first transaction, such that the cost of the transaction is split among the multiple accounts. The universal payment engine performs an authorization process for each of the second transactions with issuers associated with the multiple accounts.

If, at 412, the second transactions are all authorized, the process continues to 414. Alternatively, if one or more of the second transactions are not authorized at 412, the process may end at 416.

At 414, the plurality of second transactions are processed. The universal payment engine may cause the associated payment network to perform the processing of the transactions as would be understood by a person of ordinary skill in the art. Such processing may include interactions with the issuers associated with the multiple accounts and further interactions with the merchant and/or an associated acquirer.

In some examples, when one or more of the second transactions are not authorized or otherwise fail during processing, the payment network may respond to the merchant and/or associated acquirer with an authorization failure message, causing the first transaction to also fail. In addition to failing the first transaction, the payment network, through the universal payment engine and interface, may inform the user that one or more of the second transactions have failed and, as a result, the first transaction has failed. The user may be prompted to provide more and/or different payment information, such as selecting a different combination of accounts, or adjusting the amounts paid from the selected accounts. Once the user has provided a new set of payment information, the process may be reinitiated by receiving a multi-source payment request that includes the new set of payment information at 402.

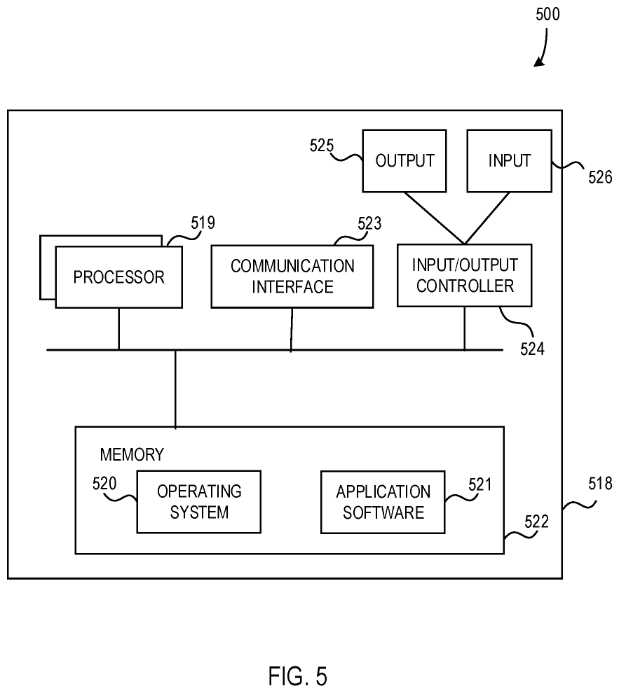

FIG. 5 is an exemplary sequence diagram 500 illustrating interactions between entities of FIG. 1 during the initiation of a multi-source payment. At 502, the user, via the user device 104, initiates a multi-source payment at the payment network 112. The multi-source payment may be initiated by interacting with the universal payment engine 122 and interface 120 of the payment network 112 as described herein. The user may be prompted to provide a selection of user accounts for use in paying for a transaction and amounts to be paid from each selected account. Further, the user may be prompted to provide a merchant identifier or other merchant information and/or transaction data including a total transaction amount. Alternatively, or additionally, the initiation of a multi-source payment may be associated with the user interacting with an interface of the merchant and/or associated APIs between the merchant interface and the payment network 112. For instance, when a user is prompted to enter payment information for an online purchase on a merchant website, the user may be redirected to the universal payment interface of the payment network 112 based on an API of the universal payment interface exposed for use by the merchant.

At 504, the payment network 112 recommends payment accounts for the user to select. The recommendations may be made based on defined user preferences, merchant data, and/or transaction context data. Further, recommendations may be made based on the past account selections (e.g., if the user has frequently used a particular credit card account in universal payments in the past, the account may be recommended for use by the payment network at 504, etc.).

At 506, the user, via the user device 104, completes the multi-source payment request by providing the account selections, transaction amounts, and any other transaction information to the payment network, as described herein. At 508, the payment network generates a virtual account identifier based on the multi-source payment request and provides it to the user device 104 for use by the user.

In some examples, the user may select accounts based on the recommendations provided. Alternatively, or additionally, the user may select an account or accounts that are not recommended from a list of accounts. Each account may be assigned a transaction amount as described herein. In further examples, the system may be configured to enable the user to select one or more accounts as optional accounts, or backup accounts. When an optional account is selected for a transaction, it may be used by the payment network 112 during processing to replace other selected accounts that are not authorized or that otherwise fail during processing. For instance, a user selects a travel rewards account and a bank account for paying for a transaction and also selects a credit card account as an optional account. During processing, authorization of the bank account fails and, rather than failing the authorization of the initial transaction, the payment network replaces the bank account with the optional credit card account and completes the authorization therewith.

At 510, the user initiates a transaction with the merchant 108 using the virtual account identifier for payment information. The merchant 108 treats the virtual account identifier as a typical account identifier and initiates transaction processing with the payment network 112 at 512. The merchant 108 may initiate the transaction processing through an associated acquirer, and the acquirer may then interact with the payment network 112 according to a standard transaction process as would be understood by a person of ordinary skill in the art. In some examples, the payment network 112 may first receive an authorization request associated with the transaction from the merchant 108 and/or an associated acquirer, wherein the authorization request includes the virtual account identifier.

At 514, the payment network 112 creates transactions with the issuers of the accounts previously selected by the user for payment of the initial transaction. This may include sending authorization messages for each of the selected accounts including the associated transaction amounts to the associated issuers 114-116. The issuers 114-116 perform authorization operations based on the received requests at 516 and respond to the payment network 112 based on the results of the authorization operations. When all of the transactions with the issuers 114-116 are authorized, the payment network 112 may respond to an authorization request associated with the initial transaction by authorizing the initial transaction to the merchant 108 at 518.

At 520, the processing of the transactions (e.g., the initial transaction and the transactions with the accounts selected by the user in the multi-source payment request, etc.) is completed through interactions between the merchant 108, the payment network 112, and the issuers 114-116. The completion of transactions may be performed by methods that would be understood by a person of ordinary skill in the art without departing from the description herein.

In some examples, the processing of the initial transaction may result in a payment of funds from a payment entity associated with the payment network to an account of the merchant 108 and the paying entity being paid by the selected user accounts based on the created secondary transactions. The use of the payment entity as a middle-man fully insulates the merchant 108 from the multiple transactions created as a result of the user's universal payment. Further, the functionality may insulate issuers and expose merchants to broader, more varied payment options and/or scenarios (e.g., real-time payment scenarios, etc.).

Additional Example Scenarios

Aspects of the disclosure enable various additional scenarios, such as next described.

In an example, a user accesses a merchant website to shop for a plane flight. The user selects a plane ticket for purchase and determines the total cost to purchase the flight. Then the user accesses a universal payment service provided by a payment network. The user opens a universal payment configuration GUI provided by the payment network and logs in to a user profile. The user inputs a merchant identifier of the merchant and the total cost amount for the desired plane ticket. The GUI displays a set of three payment accounts that the user can select from for use with the universal payment being configured. The universal payment engine of the payment network determines that a credit card account of the user offers increased loyalty reward points for travel-based purchases and so, the universal payment engine highlights the credit card account on the GUI as being recommended. The GUI further displays that the recommendation is based on the offered loyalty reward points associated with the account. The universal payment engine further recommends a bank account that the user has configured as being a preferred account.

The user selects both the recommended credit card account and the recommended bank account for use in paying for the plane ticket. The user selects to split the cost of the plane ticket equally between the two selected accounts, and then selects to complete the configuration of the universal payment. The universal payment engine then generates a virtual account identifier associated with the configured universal payment and displays the virtual account identifier to the user on the GUI. The user returns to the merchant website and selects to purchase the selected plane ticket and is prompted to enter payment information. The user enters the virtual account identifier as an account number for use in paying for the plane ticket and initiates the payment.

The merchant initiates authorization of the transaction, causing an authorization request including the virtual account identifier to be sent to the payment network. The payment network recognizes the virtual account identifier and, as a result, causes the universal payment engine to create secondary transactions associated with each of the selected accounts of the universal payment. The payment network initiates authorization of both secondary transactions and, upon receiving successful feedback for the authorizations, the payment network responds to the authorization request from the merchant with an authorization success message. The system proceeds to complete the processing of the initial transaction and the associated secondary transactions, resulting in the merchant being paid for the purchased plane ticket using funds from both selected accounts.

In a similar example, the user accesses a merchant website to shop for a hotel stay. The user selects a hotel location and a length of stay and determines the total cost to purchase the selected hotel stay. The hotel merchant website is configured to use APIs of the universal payment service as described herein, such that the user is provided a portal to the access universal payment services from within the hotel merchant website. The user is shown an interface that includes a recommended credit card account associated with the merchant that with offer rewards for the purchase. After selecting an account or a combination of accounts as described above, the user proceeds in the payment process on the merchant website. The universal payment service APIs used by the merchant website are configured to transfer a virtual account identifier to the merchant website for use during the transaction without additional interaction from the user. Upon final confirmation of the transaction by the user, the merchant initiates authorization of the transaction as described, causing an authorization request including the virtual account identifier to be sent to the payment network. The payment network proceeds to handle the universal payment transaction as described above and the transaction is completed.

### Exemplary Operating Environment

The present disclosure is operable with a computing apparatus according to an embodiment as a functional block diagram 600 in FIG. 6. In an embodiment, components of a computing apparatus 618 may be implemented as a part of an electronic device according to one or more embodiments described in this specification. The computing apparatus 618 comprises one or more processors 619 which may be microprocessors, controllers or any other suitable type of processors for processing computer executable instructions to control the operation of the electronic device. Platform software comprising an operating system 620 or any other suitable platform software may be provided on the apparatus 618 to enable application software 621 to be executed on the device. According to an embodiment, processing a transaction with multiple payment accounts by a payment network as described herein may be accomplished by software.

Computer executable instructions may be provided using any computer-readable media that are accessible by the computing apparatus 618. Computer-readable media may include, for example, computer storage media such as a memory 622 and communications media. Computer storage media, such as a memory 622, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that the storage may be distributed or located remotely and accessed via a network or other communication link (e.g. using a communication interface 623).

The computing apparatus 618 may comprise an input/output controller 624 configured to output information to one or more output devices 625, for example a display or a speaker, which may be separate from or integral to the electronic device. The input/output controller 624 may also be configured to receive and process an input from one or more input devices 626, for example, a keyboard, a microphone or a touchpad. In one embodiment, the output device 625 may also act as the input device. An example of such a device may be a touch sensitive display. The input/output controller 624 may also output data to devices other than the output device, e.g. a locally connected printing device. In some embodiments, a user may provide input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:
A system for processing a first transaction across multiple accounts comprising:
at least one processor;
at least one network interface; and
at least one memory comprising computer program code, the at least one memory and the computer program code configured to, with the at least one processor, cause the at least one processor to:
receive, via a network connection on the network interface, a multi-source payment request associated with the first transaction, wherein the request is associated with source account identifiers of the multiple accounts and the request includes a merchant identifier of a merchant associated with the first transaction and transaction data including a first amount of the first transaction;
generate a virtual account identifier associated with the multi-source payment request;
provide, via the network connection, the generated virtual account identifier to the merchant in response to the multi-source payment request;
receive, from the merchant, an authorization request associated with the first transaction, the authorization request including the virtual account identifier;
create a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
cause the plurality of second transactions to be processed, whereby the first transaction is processed and the merchant is insulated from processing the plurality of second transactions.
wherein the at least one memory and the computer program code are configured to, with the at least one processor, further cause the at least one processor to:
based on an authorization of at least one of the plurality of second transactions failing, respond to the authorization request with an authorization failure message; and
based on authorizations of all of the plurality of second transactions succeeding, respond to the authorization request with an authorization success message.
wherein causing the plurality of second transactions to be processed includes causing the transaction amounts of the plurality of second transactions to be paid from the associated multiple accounts to an account of the merchant.
wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.
wherein the selection of user payment accounts includes selection of transaction amounts to be paid from each of the selected user payment accounts.
wherein receiving the multi-source payment request further includes:
receiving, via the network connection, context data associated with the first transaction;
accessing user preference data associated with the user payment profile; and
providing, via the user interface, at least one payment account recommendation based on at least one of the context data and the user preference data.
wherein the at least one payment account recommendation is based on at least one of loyalty rewards associated with the context data or user-defined payment rules associated with the context data and user preference data.
wherein the user interface includes an application program interface (API) connected via a network connection to a computing device of the user.
wherein the multiple accounts include at least one of credit accounts, debit accounts, loyalty reward accounts, or gift card accounts.
A computerized method for processing a first transaction across multiple accounts, the method comprising:
receiving, via a network connection, a multi-source payment request associated with the first transaction, wherein the request is associated with source account identifiers of the multiple accounts and the request includes a merchant identifier of a merchant associated with the first transaction and transaction data including a first amount of the first transaction;
generating, by a processor, a virtual account identifier associated with the multi-source payment request;
providing, via the network connection, the generated virtual account identifier to the merchant in response to the multi-source payment request;
receiving, from the merchant, an authorization request associated with the first transaction, the authorization request including the virtual account identifier;
creating, by the processor, a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
causing, by the processor, the plurality of second transactions to be processed, whereby the first transaction is processed and the merchant is insulated from processing the plurality of second transactions.
further comprising, based on an authorization of at least one of the plurality of second transactions failing, responding to the authorization request with an authorization failure message; and
based on authorizations of all of the plurality of second transactions succeeding, responding to the authorization request with an authorization success message.
wherein causing the plurality of second transactions to be processed includes causing the transaction amounts of the plurality of second transactions to be paid from the associated multiple accounts to an account of the merchant.
wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.
wherein the selection of user payment accounts includes selection of transaction amounts to be paid from each of the selected user payment accounts.
wherein receiving the multi-source payment request further includes:
receiving, via the network connection, context data associated with the first transaction;
accessing user preference data associated with the user payment profile; and
providing, via the user interface, at least one payment account recommendation based on at least one of the context data and the user preference data.
wherein the at least one payment account recommendation is based on at least one of loyalty rewards associated with the context data or user-defined payment rules associated with the context data and user preference data.
One or more computer storage media having computer-executable instructions for processing a first transaction across multiple accounts that, upon execution by a processor, cause the processor to at least:
receive, via a network connection, a multi-source payment request associated with the first transaction, wherein the request is associated with source account identifiers of the multiple accounts and the request includes a merchant identifier of a merchant associated with the first transaction and transaction data including a first amount of the first transaction;
generate a virtual account identifier associated with the multi-source payment request;
provide, via the network connection, the generated virtual account identifier to the merchant in response to the multi-source payment request;
receive, from the merchant, an authorization request associated with the first transaction, the authorization request including the virtual account identifier;
create a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
cause the plurality of second transactions to be processed, whereby the first transaction is processed and the merchant is insulated from processing the plurality of second transactions.
wherein the computer-executable instructions, with the at least one processor, further cause the processor to at least:
based on an authorization of at least one of the plurality of second transactions failing, respond to the authorization request with an authorization failure message; and
based on authorizations of all of the plurality of second transactions succeeding, respond to the authorization request with an authorization success message.
wherein causing the plurality of second transactions to be processed includes causing the transaction amounts of the plurality of second transactions to be paid from the associated multiple accounts to an account of the merchant.
wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving a multi-source payment request associated with a first transaction, means for generating a virtual account identifier associated with the multi-source payment request, means for providing the generated virtual account identifier to a merchant in response to the multi-source payment request, means for receiving an authorization request associated with the first transaction, the authorization request including the virtual account identifier, means for creating a plurality of second transactions based on the multi-source payment request, wherein the plurality of second transactions are associated with source account identifiers of multiple accounts, wherein a sum of transaction amounts of the plurality of second transactions equal a transaction amount of the first transaction, and means for causing the plurality of second transactions to be processed, whereby the first transaction is processed and the merchant is insulated from processing the plurality of second transactions. The illustrated one or more processors 619 together with the computer program code stored in memory 622 constitute exemplary processing means for generating a virtual account identifier, recommending at least one source account, and creating and managing a plurality of second transactions between a payment network and issuers as described herein.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for processing a first transaction across multiple accounts comprising:
at least one processor;
at least one network interface; and
at least one memory comprising computer program code, the at least one memory and the computer program code configured to, with the at least one processor, cause the at least one processor to:
receive, via a network connection on the network interface, a multi-source payment request associated with the first transaction, wherein the request is associated with source account identifiers of the multiple accounts and the request includes a merchant identifier of a merchant associated with the first transaction and transaction data including a first amount of the first transaction;
generate a virtual account identifier associated with the multi-source payment request;
provide, via the network connection, the generated virtual account identifier to the merchant in response to the multi-source payment request;
receive, from the merchant, an authorization request associated with the first transaction, the authorization request including the virtual account identifier;
create a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
cause the plurality of second transactions to be processed, whereby the first transaction is processed and the merchant is insulated from the processing of the plurality of second transactions.

2. The system of claim 1, wherein the at least one memory and the computer program code are configured to, with the at least one processor, further cause the at least one processor to:
based on an authorization of at least one of the plurality of second transactions failing, respond to the authorization request with an authorization failure message; and
based on authorizations of all of the plurality of second transactions succeeding, respond to the authorization request with an authorization success message.

3. The system of claim 1, wherein causing the plurality of second transactions to be processed includes causing the transaction amounts of the plurality of second transactions to be paid from the associated multiple accounts to an account of the merchant.

4. The system of claim 1, wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.

5. The system of claim 4, wherein the selection of user payment accounts includes selection of transaction amounts to be paid from each of the selected user payment accounts.

6. The system of claim 4, wherein receiving the multi-source payment request further includes:
receiving, via the network connection, context data associated with the first transaction;
accessing user preference data associated with the user payment profile; and
providing, via the user interface, at least one payment account recommendation based on at least one of the context data and the user preference data.

7. The system of claim 6, wherein the at least one payment account recommendation is based on at least one of loyalty rewards associated with the context data or user-defined payment rules associated with the context data and user preference data.

8. The system of claim 4, wherein the user interface includes an application program interface (API) connected via a network connection to a computing device of the user.

9. The system of claim 1, wherein the multiple accounts include at least one of credit accounts, debit accounts, loyalty reward accounts, or gift card accounts.

10. A computerized method for processing a first transaction across multiple accounts, the method comprising:
receiving, via a network connection, a multi-source payment request associated with the first transaction, wherein the request is associated with source account identifiers of the multiple accounts and the request includes a merchant identifier of a merchant associated with the first transaction and transaction data including a first amount of the first transaction;
generating, by a processor, a virtual account identifier associated with the multi-source payment request;
providing, via the network connection, the generated virtual account identifier to the merchant in response to the multi-source payment request;
receiving, from the merchant, an authorization request associated with the first transaction, the authorization request including the virtual account identifier;
creating, by the processor, a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
causing, by the processor, the plurality of second transactions to be processed, whereby the first transaction is processed and the merchant is insulated from the processing of the plurality of second transactions.

11. The computerized method of claim 10, further comprising:
based on an authorization of at least one of the plurality of second transactions failing, responding to the authorization request with an authorization failure message; and
based on authorizations of all of the plurality of second transactions succeeding, responding to the authorization request with an authorization success message.

12. The computerized method of claim 10, wherein causing the plurality of second transactions to be processed includes causing the transaction amounts of the plurality of second transactions to be paid from the associated multiple accounts to an account of the merchant.

13. The computerized method of claim 10, wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.

14. The computerized method of claim 13, wherein the selection of user payment accounts includes selection of transaction amounts to be paid from each of the selected user payment accounts.

15. The computerized method of claim 13, wherein receiving the multi-source payment request further includes:
receiving, via the network connection, context data associated with the first transaction;
accessing user preference data associated with the user payment profile; and
providing, via the user interface, at least one payment account recommendation based on at least one of the context data and the user preference data.

16. The computerized method of claim 15, wherein the at least one payment account recommendation is based on at least one of loyalty rewards associated with the context data or user-defined payment rules associated with the context data and user preference data.

17. One or more computer storage media having computer-executable instructions for processing a first transaction across multiple accounts that, upon execution by a processor, cause the processor to at least:
receive, via a network connection, a multi-source payment request associated with the first transaction, wherein the request is associated with source account identifiers of the multiple accounts and the request includes a merchant identifier of a merchant associated with the first transaction and transaction data including a first amount of the first transaction;
generate a virtual account identifier associated with the multi-source payment request;
provide, via the network connection, the generated virtual account identifier to the merchant in response to the multi-source payment request;
receive, from the merchant, an authorization request associated with the first transaction, the authorization request including the virtual account identifier;
create a plurality of second transactions based on the multi-source payment request, wherein the plurality of second transactions are associated with the source account identifiers of the multiple accounts, wherein a sum of transaction amounts of the plurality of second transactions equals the first amount of the first transaction; and
cause the plurality of second transactions to be processed, whereby the first transaction is processed and the merchant is insulated from the processing of the plurality of second transactions.

18. The one or more computer storage media of claim 17, wherein the computer-executable instructions, with the at least one processor, further cause the processor to at least:
based on an authorization of at least one of the plurality of second transactions failing, respond to the authorization request with an authorization failure message; and
based on authorizations of all of the plurality of second transactions succeeding, respond to the authorization request with an authorization success message.

19. The one or more computer storage media of claim 17, wherein causing the plurality of second transactions to be processed includes causing the transaction amounts of the plurality of second transactions to be paid from the associated multiple accounts to an account of the merchant.

20. The one or more computer storage media of claim 17, wherein receiving the multi-source payment request includes:
providing a user access to a user payment profile via a user interface, the user payment profile including a plurality of user payment accounts;
receiving, as input from the user interface, a selection of user payment accounts from the plurality of user payment accounts, the selection including the multiple accounts of the multi-source payment request;
receiving, as input from the user interface, the merchant identifier of the multi-source payment request; and
receiving, as input from the user interface, the transaction data of the multi-source payment request.
